(19) United States
(12) Patent Application Publication
(10) Pub. No.: US 2015/0223025 A1
(43) Pub. Date: Aug. 6, 2015

(54) METHODS AND SYSTEMS FOR SHARING CHARGING RESOURCES

(71) Applicants: Solomon AVITAL, Berlin (DE); Yaniv HAMAMA, Ramat-Gan (IL)

(72) Inventor: Solomon AVITAL, Berlin (DE)

(21) Appl. No.: 14/613,557

(22) Filed: Feb. 4, 2015

Related U.S. Application Data
(60) Provisional application No. 61/935,407, filed on Feb. 4, 2014.

(51) Int. Cl. H04W 4/02; H04L 12/58; G06F 17/30; H04W 4/04

(52) U.S. Cl. CPC H04W 4/023; H04W 4/043; H04L 51/20; H04L 51/32; G06F 17/3053

(57) ABSTRACT

A method for mapping a current geographic location of each of a plurality of portable battery charging entities, comprising: monitoring a current geographical location and a charging capability indicator of a plurality of mobile client devices used by a plurality of subscribers, the charging capability indicator indicates whether one of the mobile client devices is in a charging status, apt to perform a charging session using a charging device or in a non charging status, not apt to perform the charging session; identifying a first mobile client device that requires performing the charging session; selecting at least one host mobile client device which is located within a predefined range from a first current geographical location of the first mobile client device and being in the charging status; and sending instructions indicative of a current geographical location of the host mobile client device to the first mobile client device.

### RELATED APPLICATION

This application claims the benefit of priority under 35 USC 119(e) of U.S. Provisional Patent Application No. 61/935,407 filed Feb. 4, 2014, the contents of which are incorporated herein by reference in their entirety.

### FIELD AND BACKGROUND OF THE INVENTION

The present invention, in some embodiments thereof, relates to sharing charging resources and, more particularly, but not exclusively, to sharing charging resources using mobile client devices.

Mobile phones require frequent charging of their battery. This results in many users of mobile phones who are carrying a charger with them. Some users of mobile phones do not carry a charger with them, or may find themselves in a location with no power outlet.

Some existing chargers for mobile phones contain a battery for charging the mobile phone when a power outlet is unavailable.

### SUMMARY OF THE INVENTION

According to an aspect of some embodiments of the present invention there is provided a method for mapping a current geographic location of each of a plurality of portable battery charging entities, comprising: monitoring a current geographical location and a charging capability indicator of a plurality of mobile client devices used by a plurality of subscribers, the charging capability indicator indicates whether one of the plurality of mobile client devices is in a charging status, apt to perform a charging session using a charging device or in a non charging status, not apt to perform the charging session; identifying a first mobile client device that requires performing the charging session; selecting at least one host mobile client device which is located within a predefined range from a first current geographical location of the first mobile client device and being in the charging status; and sending instructions indicative of a current geographical location of the at least one host mobile client device to the first mobile client device.

Optionally, the method is performed by at least one central server which is connected to the plurality of mobile client devices via a network.

Optionally, the identifying comprises: receiving a first request to perform the charging session from a first of the plurality of mobile client devices, the request comprises a first current geographical location of the first mobile client device.

Optionally, the identifying comprises: monitoring battery status of a plurality of mobile client devices to identify low battery condition.

Optionally, the selecting comprises: identifying a group from the plurality of mobile client devices which is located within a predefined range from a first current geographical location of the first mobile client device and being in the charging status according to an analysis of the current geographical location and the charging capability indicator per each one of the plurality of subscribers; sending members of the group a request message indicating a request to perform the charging session by the first mobile client device; receiving a plurality of responses to the request message from a plurality of members of the group, each of the plurality of responses comprises a user input received from a respective one of the plurality of subscribers; and analyzing the plurality of responses to identify at least one host mobile client device from the group which is ready to perform the charging session.

Optionally, the selecting is performed using a social network.

Optionally, the method further comprises: ranking a respective subscriber of the at least one host mobile client device after performing the charging session.

Optionally, the method further comprises: ranking a respective subscriber of a mobile client device when the subscriber is willing to perform the charging session.

Optionally, the charging capability indicator includes types of mobile client devices compatible with the charging device.

According to an aspect of some embodiments of the present invention there is provided a system for mapping a geographic location of a plurality of battery charging entities, comprising: a plurality of mobile client devices used by a plurality of subscribers, each one of the plurality of mobile client devices having a charging capability indicator that indicates whether the mobile client device is in a charging status, apt to perform a charging session using a charging device or in a non charging status, not apt to perform the charging session; a plurality of charging modules each installed in one of the plurality of mobile client devices; a first mobile client device that requires performing the charging session; at least one host mobile client device which is located within a predefined range from a first current geographical location of the first mobile client device and being in the charging status; and at least one central server, connected to the plurality of mobile client devices via a network, which: monitors a current geographical location and a charging capability indicator of the plurality of subscribers using the plurality of charging modules; identifies the first mobile client device; selects the at least one host mobile client device; and sends instructions indicative of a current geographical location of the at least one host mobile client device to the first mobile client device.

According to an aspect of some embodiments of the present invention there is provided a method for ranking a plurality of subscribers, comprising: identifying a charging event of a foreign mobile device by a charging device associated with a subscriber; sending a first message indicative of the event from the charging device to at least one primary mobile device; forwarding a second message indicative of the event from the at least one primary mobile device to at least one central server which is connected to the at least one primary mobile device via a network; and ranking the subscriber according to the second message.

Optionally, the identifying comprises: recording at least one primary identifier of at least one primary mobile device; acquiring a current identifier of a currently charged mobile device which is electronically connected to the charging device; performing a match between the current identifier and the at least one primary identifier; and identifying according to the match an event of charging a foreign mobile device using the charging device.

Optionally, the ranking is performed by the at least one central server.

According to an aspect of some embodiments of the present invention there is provided a method for ranking a plurality of subscribers, comprising: identifying a charging event of a foreign mobile device by a charging device; creating a message indicative of the event; sending the message from the charging device to at least one central server; and ranking the subscriber according to the message.

According to an aspect of some embodiments of the present invention there is provided a system for ranking a plurality of subscribers, comprising: at least one primary mobile device associated with a subscriber; a foreign mobile device; a charging device associated with the subscriber which identifies a charging event by the foreign mobile device and sends a first message indicative of the event to the at least one primary mobile device; and at least one central server connected to the at least one primary mobile device via a network which receives a second message indicative of the event forwarded from the at least one primary mobile device and ranks the subscriber according to the second message.

According to an aspect of some embodiments of the present invention there is provided a method for mapping a geographic location of a plurality of publically available power outlets, comprising: storing a dataset of publically available power outlets and respective geographical locations; receiving at least one message from at least one mobile client device, the at least one message comprises a geographical location of a publically available power outlet; and updating the dataset according to the at least one message.

Optionally, the at least one message further comprises an image of the publically available power outlet.

Optionally, the method further comprises: ranking a respective subscriber which is the owner of the at least one mobile client devices.

Optionally, the method is performed by at least one central server which is connected to the plurality of mobile client devices via a network.

Optionally, the method, of also mapping a current geographic location of each of a plurality of portable battery charging entities, further comprises: monitoring a current geographical location of a plurality of mobile client devices used by a plurality of subscribers, each having a charging device; identifying a first mobile client device that requires performing a charging session; selecting at least one host mobile client device which is located within a predefined range from a first current geographical location of the first mobile client device; locating a publically available power outlet proximate to the at least one host mobile client device; and sending instructions indicative of a current geographical location of the at least one host mobile client device and the proximate publically available power outlet to the first mobile client device.

According to an aspect of some embodiments of the present invention there is provided a system for mapping a geographic location of a plurality of publically available power outlets, comprising: a dataset of publically available power outlet and respective geographical locations; at least one mobile client device which sends at least one message, the at least one message comprises a geographical location of a publically available power outlet; and at least one central server connected to the plurality of mobile client devices via a network which receives the at least one message and updates the dataset according to the at least one message.

Unless otherwise defined, all technical and/or scientific terms used herein to have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system for sharing charging resources using mobile client devices, according to some embodiments of the present invention;

FIG. 2 is a flowchart schematically representing a method for mapping a current geographic location of each of a plurality of portable battery charging entities, according to some embodiments of the present invention;

FIG. 3 is a flowchart schematically representing a method for ranking a plurality of subscribers, according to some embodiments of the present invention;

FIG. 4 is a flowchart schematically representing a method for mapping a geographic location of a plurality of publically available power outlets, according to some embodiments of the present invention; and

FIG. 5 is a schematic illustration of a mobile phone display of an exemplary charging application, according to some embodiments of the present invention.

### DESCRIPTION OF EMBODIMENTS OF THE INVENTION

The present invention, in some embodiments thereof, relates to sharing charging resources and, more particularly, but not exclusively, to sharing charging resources using mobile client devices.

A mobile client device may be, for example, a mobile phone, a tablet computer, a laptop computer and/or any other portable electronic device.

According to some embodiments of the present invention, there is provided a method for mapping a current geographic location of each of a plurality of portable battery charging entities of a plurality of subscribers, such as social network peers. The mapping provides subscribers that need charging of their mobile client devices with the ability to find other subscribers that have an available charging device in proximity thereto and to ask them to contribute the charging device for battery charging session. A charging device may be any kind of device having an output plug compatible with mobile client devices and optionally a power source, such as a battery. The charging device may also be a wireless charger, for example, using electromagnetic induction such as by Qi interface standard and/or Powermat. The mapping may also map the type of devices which are supported by the charging devices. In use, a current geographical location and a charging capability indicator of mobile client devices, used by subscribers, are monitored by local modules which are installed in client terminals of the subscribers, for example applications which are set to pull a paired device for data. The charging capability indicator indicates whether a mobile client device is in a charging status, apt to perform and/or ready to receive request for a charging session using a charging device or in a non-charging status, not apt and/or not ready to receive request for to perform the charging session. A guest mobile client device that requires performing a charging session is identified and host mobile client device close to the guest mobile client device and is in charging status is selected. For example, a request to perform the charging session is received with a current geographical location from a guest mobile client device. A group of mobile client devices close to the guest mobile client device and in a charging status is identified and a request is sent to the group. Responses to the request are received from members of the group and are analyzed to identify at least one member of the group ready to perform the charging session. The guest mobile client device may be identified automatically when its battery is low. The host mobile client device may be selected using a social network. Instructions containing the location of the member mobile client device are sent to the guest mobile client device and the subscriber then finds the subscriber of the member mobile client device and uses his charging device to charge the guest mobile client device. Optionally, the subscriber of the member mobile client device is then ranked. The subscriber may be ranked according to willingness to perform charging sessions and/or according to actual charging sessions performed.

According to some embodiments of the present invention, there is provided a method for ranking a plurality of subscribers. The ranking provides an incentive for subscribers to share their charging device with other subscribers who are in need of charging their mobile client devices at a convenient time. A charging event of a foreign mobile device by a charging device associated with a subscriber is identified. A foreign mobile device may be any device belonging to a subscriber other then the owner of the charging device. The identification may be performed by recording a primary identifier of a primary mobile device, acquiring a current identifier of a currently charged mobile device which is electronically connected to charging device and matching between the current identifier and the primary identifier. A message indicative of the event is sent from the charging device to the primary mobile device and forwarded to a central server which is connected to the primary mobile device via a network. The subscriber is then ranked according to the message.

According to some embodiments of the present invention, there is provided a method for mapping a geographic location of a plurality of publically available power outlets. The publically available power outlets may be located, for example, at an airport, a restaurant, a train station, a bank and/or any other accessible public or private location. The mapping provides subscribers that need charging of their mobile client devices to find a publically available power outlet close to their location. A dataset of publically available power outlets and respective geographical locations is stored. Then, a message with a geographical location of a publically available power outlet from a mobile client device is received. Optionally, the message also includes an image of the publically available power outlet. The dataset is then updated according to the message. Optionally, the subscriber which is the owner of the mobile client device is ranked for sending the message. Other subscribers may then find the publically available power outlet according to the mapping.

The above outlined methods may be combined, for example, by locating a proximate subscriber with a charging device located close to a publically available power outlet and using both the charging device and the power outlet to charge a guest mobile client device.

The above outlined methods may be performed by a central server connected to the mobile client devices via a network. The central server may be, for example, a remote server computing device, personal computing device, and/or any other device that has sufficient processor and storage abilities. The network may include, for example wireless local area network (WLAN) protocol such as Wireless Fidelity (WiFi™), a wireless personal area network (WPAN) such as Bluetooth™ protocol and/or a cellular network.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

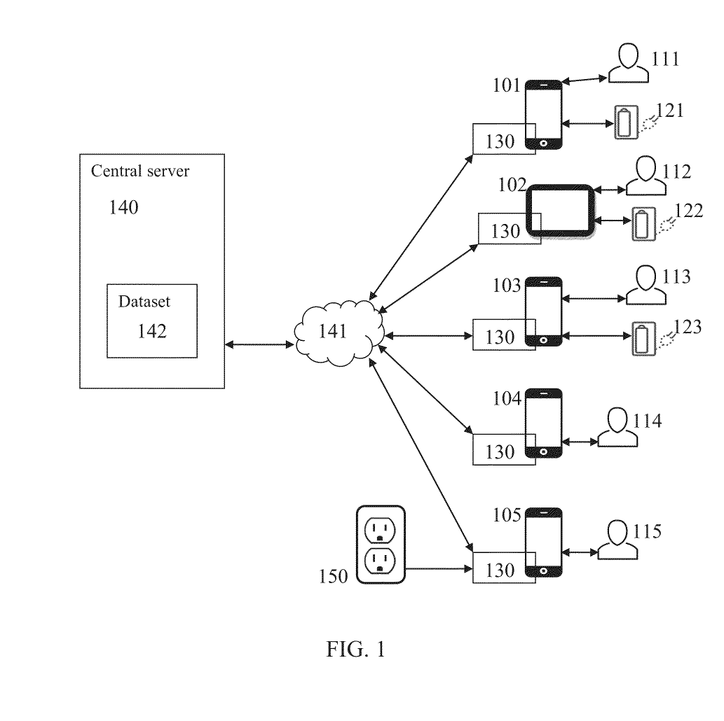

Referring now to the drawings, FIG. 1 is a schematic illustration of a system for sharing charging resources using mobile client devices, according to some embodiments of the present invention.

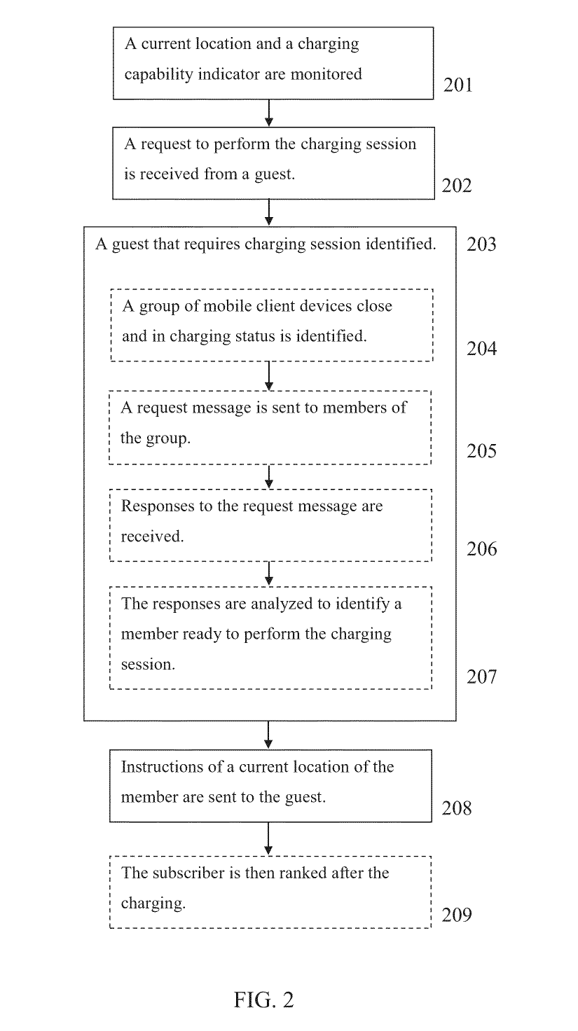

Reference is also made to FIG. 2, which is a flowchart schematically representing a method for mapping a current geographic location of each of a plurality of portable battery charging entities, according to some embodiments of the present invention.

First, as shown at 201, a current geographical location and a charging capability indicator of mobile client devices 101-103 used by subscribers 111-113 are monitored. Optionally, each one of mobile client devices 101-103 is using a charging module 130 installed in mobile client devices 101-103. Charging module 130 may be, for example, applications set to pull a paired device for data. The charging capability indicator indicates whether one of mobile client devices 101-103 is in a charging status, apt to perform and/or ready to receive request for a charging session using a respective charging device 121-123 or in a non-charging status, not apt to perform and/or not ready to receive request for the charging session. Optionally, the charging capability indicators of mobile client devices 101-103 are managed by charging modules 130. Optionally, the charging capability indicator includes types of mobile client devices compatible with said charging device, for example, devices using Apple connector, miniUSB, microUSB and/or any other connector.

Then, as shown at 202, a guest mobile client device that requires performing said charging session is identified.

Optionally, the identification includes a request to perform the charging session that is received from a guest charging module 131 installed on a guest mobile client device 104 used by subscriber 114. The request comprises the current geographical location of guest mobile client device 104.

Optionally, the identification is performed automatically by monitoring the battery status of guest mobile client device 104 and identifying low-battery condition. For example, guest mobile client device 104 is identified when the battery is 30%, 20% and/or 10% charged, and/or any other intermediate, higher or lower number. Optionally, the number is predefined or defined by subscriber 114.

Then, as shown at 203, at least one host mobile client device which is located within a predefined range from the current geographical location of guest mobile client device 104 and being in said charging status is selected.

Optionally, the selection is performed as shown at 304-307.

First, as shown at 204, a group of mobile client devices 102-103 from mobile client devices 101-103 is identified. The members 102-103 of the group are located within a predefined range from the current geographical location of guest mobile client device 104 and are in charging status. The group is identified according to an analysis of the current geographical location and the charging capability indicator per each one of mobile client devices 102-103.

Then, as shown at 205, a request message is sent to members 102-103 of the group. The message is indicating a request to perform the charging session by guest mobile client device 114. Optionally, the request message includes other details of subscriber 114 and/or guest mobile client device 104, for example, battery status, current location, rank status and/or personal details. Optionally, the request message is sent only to some of members 102-103 according to instructions from subscriber 114.

Then, as shown at 206, responses to the request message are received from members 102-103 of the group. The responses include a user input received from respective subscribers 112-113. For example, subscriber 112 may be unavailable to perform the charging session, for example, during a meeting and/or leaving the current location.

Finally, as shown at 207, the responses are analyzed to identify at least one member 103 of the group which is ready to perform the charging session.

Optionally, the selection is performed according to social networks, for example, client device 102 is selected when subscriber 112 is connected with subscriber 114 on a social network. Optionally, the selection is performed automatically when subscriber 112 is in proximity to subscriber 114.

Finally, as shown at 208, instructions indicative of a current geographical location of member 103 are sent to guest mobile client device 104. Subscriber 114 then finds subscriber 113 and uses his charging device 123 to charge guest mobile client device 104. Optionally, the instructions include details of subscriber 113, such as an image, to help subscriber 114 find subscriber 113.

Optionally, as shown at 209, subscriber 113 is then ranked after the charging of guest mobile client device 104. The ranking provides an incentive for subscribers to share their charging device with other subscribers who are in need of charging their mobile client devices at a convenient time. The ranking may include, for example, points accumulated by subscribers for share their charging device and/or levels reached by subscribers such as ‘gold member’ and/or ‘VIP member’. Optionally, the ranking provides discounted or free items. Optionally, subscriber 112 is also ranked according to the response, for willingness to perform the charging session.

Optionally, the method is performed by at least one central server which is connected to mobile client devices 101-104 via a network 141.

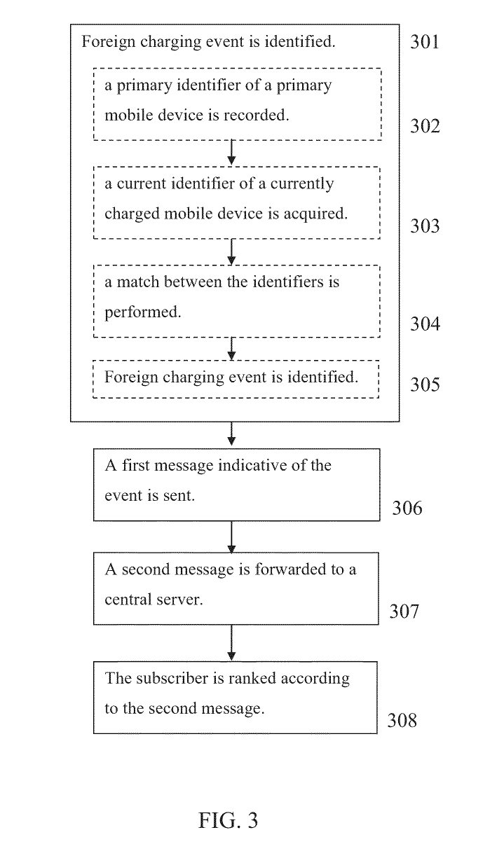

Reference is now made to FIG. 3, which is a flowchart schematically representing a method for ranking a plurality of subscribers, according to some embodiments of the present invention.

First, as shown at 301, a charging event of a foreign mobile device 104 by a charging device 123 associated with a subscriber 113 is identified.

Optionally, the identification is performed by charging device 123 as shown at 302-305.

First, as shown at 302, a primary identifier of a primary mobile device 103 is recorded. Primary mobile device 103 is the device used by subscriber 113 associated with charging device 123. Optionally, more than one primary identifier is recorded. For example, this may be done by connecting primary mobile device 103 to charging device 123 and initiating an identification process. A processor located in charging device 123 may be used to communicate with primary mobile device 103 and receive an identification code, for example, media access control (MAC) address. The identification code may be stored as a primary identifier on a memory unit in charging device 123.

Then, as shown at 303, a current identifier of a currently charged mobile device 104 which is electronically connected to charging device 123 is acquired. This may be performed in a way similar to the recording of the primary identifier.

Then, as shown at 304, a match between the current identifier and the primary identifier is performed. The matching may be performed by a processor located in charging device 123.

Finally, as shown at 305, an event of charging foreign mobile device 104 using charging device 123 is identified according to the match.

Then, as shown at 306, a first message indicative of the event is sent from charging device 123 to primary mobile device 103. This may be performed by a communication unit located in charging device 123. The communication unit may use network connection, such as WiFi and/or cellular network. The communication unit may use the charging connector to primary mobile device 103 to transfer the message when primary mobile device 103 is connected to charging device 123.

Then, as shown at 307, a second message indicative of the event is forwarded from primary mobile device 103 to a central server 140 which is connected to primary mobile device 103 via network 141. Optionally, more than one central server is used.

Finally, as shown at 308, subscriber 113 is ranked according to the second message.

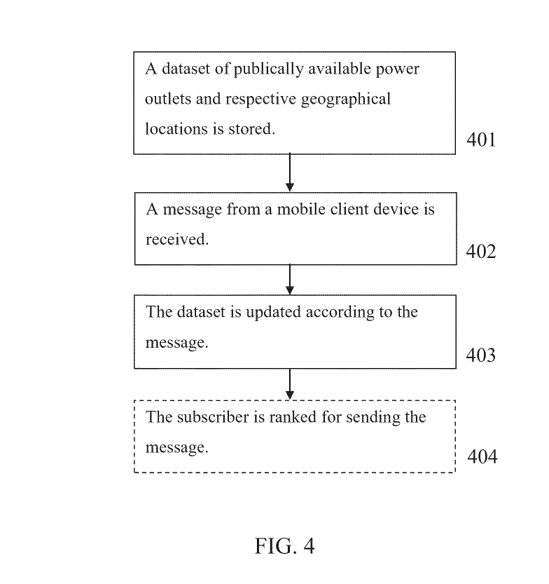

Reference is now made to FIG. 4, which is a flowchart schematically representing a method for mapping a geographic location of a plurality of publically available power outlets, according to some embodiments of the present invention.

First, as shown at 401, a dataset 142 of publically available power outlets and respective geographical locations is stored. Optionally, dataset 142 is stored in central server 140.

Then, as shown at 402, a message from a mobile client device 105 is received. The message includes a geographical location of a publically available power outlet 150. Optionally, the message also includes an image of publically available power outlet 150. Optionally, the message is received by central server 140.

Then, as shown at 403, dataset 142 is updated according to the message.

Optionally, as shown at 404, a respective subscriber 113 which is the owner of mobile client device 105 is ranked for sending the message.

Optionally, according to some embodiments of the present invention, the methods may be combined. For example, mobile client device 101 may be located in proximity to publically available power outlet 150 so guest mobile client device 104 is identified and may be directed to charge using charging device 121 and publically available power outlet 150, for example, when charging device 121 has no internal battery or low battery.

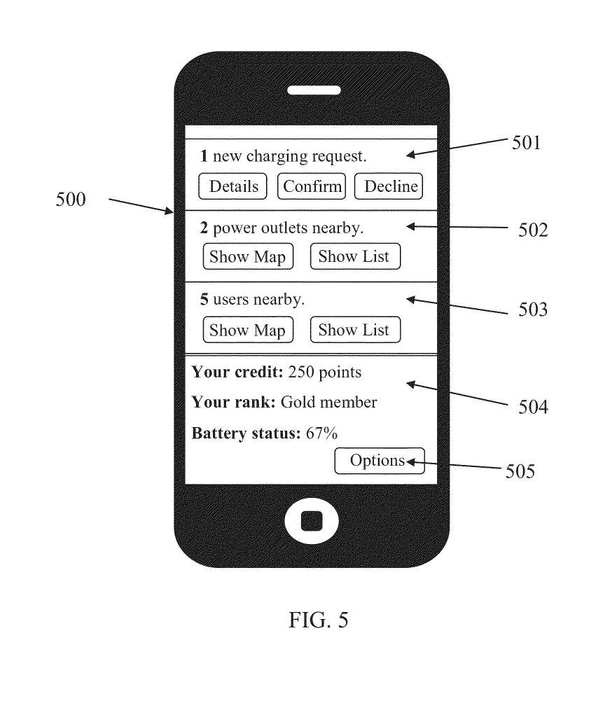

Reference is now made to FIG. 5, which is a schematic illustration of a mobile phone display 500 of an exemplary charging application, according to some embodiments of the present invention. Requests section 501 includes an alert of a charging request sent to the subscriber by other subscriber needing to charge his mobile device. Requests section 501 also includes buttons for the subscriber to confirm the request and invite the other subscriber to charge his mobile device, to decline the request and/or to view the details of the other subscriber. Power outlets section 502 includes publically available power outlets proximate to the location of the subscriber. Power outlets section 502 also includes buttons for the subscriber to view a list of the publically available power outlets or a map presenting the publically available power outlets according to location. Users section 503 includes other subscribers using the application, some with an available charging device. Users section 503 also includes buttons for the subscriber to view a list of the users with their details or a map presenting the users according to location. Details section 504 includes the details of the subscriber, such as rank, credit points and/or battery status. Options button 505 allows the subscriber to define properties of the application, such as maximal distance of other subscribers requests are received from and/or personal details such as social network identity.

In an exemplary scenario according to some embodiments of the present invention a guest subscriber has a mobile phone with low battery. The guest subscriber activates a charging application installed on his mobile phone and asks for a proximate charging solution. The application displays a proximate publically available power outlet in a coffee shop and two proximate host subscribers that are in a charging status. The guest subscriber sends a request to the host subscribers and receives a positive response from one host subscriber with instructions for finding the host subscriber. The guest subscriber finds the host subscriber and attaches his mobile phone to the guest subscriber's charging device. The charging device recognizes that a foreign device is charging and sends a message to the mobile device of the host subscriber. The host subscriber is then credited for the charging.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for sharing charging resources will be developed and the scope of the term sharing charging resources is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for mapping a current geographic location of each of a plurality of portable battery charging entities, comprising:
monitoring a current geographical location and a charging capability indicator of a plurality of mobile client devices used by a plurality of subscribers, said charging capability indicator indicates whether one of said plurality of mobile client devices is in a charging status, apt to perform a charging session using a charging device or in a non charging status, not apt to perform said charging session;
identifying a first mobile client device that requires performing said charging session;
selecting at least one host mobile client device which is located within a predefined range from a first current geographical location of said first mobile client device and being in said charging status; and
sending instructions indicative of a current geographical location of said at least one host mobile client device to said first mobile client device.

2. The method of claim 1, performed by at least one central server which is connected to said plurality of mobile client devices via a network.

3. The method of claim 1, wherein said identifying comprises:
receiving a first request to perform said charging session from a first of said plurality of mobile client devices, said request comprises a first current geographical location of said first mobile client device.

4. The method of claim 1, wherein said identifying comprises:
monitoring battery status of a plurality of mobile client devices to identify low battery condition.

5. The method of claim 1, wherein said selecting comprises:
identifying a group from said plurality of mobile client devices which is located within a predefined range from a first current geographical location of said first mobile client device and being in said charging status according to an analysis of said current geographical location and said charging capability indicator per each one of said plurality of subscribers;
sending members of said group a request message indicating a request to perform said charging session by said first mobile client device;
receiving a plurality of responses to said request message from a plurality of members of said group, each of said plurality of responses comprises a user input received from a respective one of said plurality of subscribers; and
analyzing said plurality of responses to identify at least one host mobile client device from said group which is ready to perform said charging session.

6. The method of claim 1, wherein said selecting is performed using a social network.

7. The method of claim 1, further comprising:
ranking a respective subscriber of said at least one host mobile client device after performing said charging session.

8. The method of claim 1, further comprising:
ranking a respective subscriber of a mobile client device when said subscriber is willing to perform said charging session.

9. The method of claim 1, wherein said charging capability indicator includes types of mobile client devices compatible with said charging device.

10. The method of claim 1, further comprising:
storing a dataset of publically available power outlets and respective geographical locations;
receiving at least one message from at least one mobile client device of said plurality of mobile client devices, said at least one message comprises a geographical location of a publically available power outlet; and
updating said dataset according to said at least one message.

11. The method of claim 10, wherein said at least one message further comprises an image of said publically available power outlet.

12. The method of claim 10, further comprising:
ranking a respective subscriber which is the owner of said at least one mobile client devices.

13. The method of claim 10, performed by at least one central server which is connected to said plurality of mobile client devices via a network.

14. The method of claim 10, of also mapping a current geographic location of each of a plurality of portable battery charging entities, further comprising:
monitoring a current geographical location of a plurality of mobile client devices used by a plurality of subscribers, each having a charging device;
identifying a first mobile client device that requires performing a charging session;
selecting at least one host mobile client device which is located within a predefined range from a first current geographical location of said first mobile client device;
locating a publically available power outlet proximate to said at least one host mobile client device; and
sending instructions indicative of a current geographical location of said at least one host mobile client device and said proximate publically available power outlet to said first mobile client device.

15. A system for mapping a geographic location of a plurality of battery charging entities, comprising:
a plurality of mobile client devices used by a plurality of subscribers, each one of said plurality of mobile client devices having a charging capability indicator that indicates whether said mobile client device is in a charging status, apt to perform a charging session using a charging device or in a non charging status, not apt to perform said charging session;
a plurality of charging modules each installed in one of said plurality of mobile client devices;
a first mobile client device that requires performing said charging session;
at least one host mobile client device which is located within a predefined range from a first current geographical location of said first mobile client device and being in said charging status; and
at least one central server, connected to said plurality of mobile client devices via a network, which:
monitors a current geographical location and a charging capability indicator of said plurality of subscribers using said plurality of charging modules;
identifies said first mobile client device;
selects said at least one host mobile client device; and
sends instructions indicative of a current geographical location of said at least one host mobile client device to said first mobile client device.

16. A method for ranking a plurality of subscribers, comprising:
identifying a charging event of a foreign mobile device by a charging device associated with a subscriber;
sending a first message indicative of said event from said charging device to at least one primary mobile device;
forwarding a second message indicative of said event from said at least one primary mobile device to at least one central server which is connected to said at least one primary mobile device via a network; and
ranking said subscriber according to said second message.

17. The method of claim 16, wherein said identifying comprises:
recording at least one primary identifier of at least one primary mobile device;
acquiring a current identifier of a currently charged mobile device which is electronically connected to said charging device;
performing a match between said current identifier and said at least one primary identifier; and
identifying according to said match an event of charging a foreign mobile device using said charging device.

18. The method of claim 16, wherein said ranking is performed by said at least one central server.
